(19) United States
(12) Patent Application Publication
(10) Pub. No.: US 2003/0159841 A1
(43) Pub. Date: Aug. 28, 2003

(54) Weed extraction home gardening tool

(76) Inventor: Charles Hall, Madera, CA (US)

Correspondence Address: MARK D MILLER, KIMBLE, MACMICHAEL & UPTON, 5260 NORTH PALM AVENUE, SUITE 221, FRESNO, CA, 93704, US

(21) Appl. No.: 10/084,792

(22) Filed: Feb. 25, 2002

(51) Int. Cl. A01B 1/00

(52) U.S. Cl. 172/375; 172/378

(57) ABSTRACT

A combined home garden tool for easily and efficiently removing weeds, digging or leveling of soil, and planting which does not require repetitive kneeling or stooping. The invention includes a long or short handle attached to a unique head having a combined weed remover, pointed or flat trenching tool and soil leveler. The weed removal section includes a set of generally parallel elongated tines with pointed ends, the tines being spaced apart from each other to form as set of narrow V-shaped openings for engagement with weeds that accomplishes removal of the weeds and substantially all of their associated root systems without requiring repetitive kneeling or stooping.

### BACKGROUND OF THE INVENTION

1. Field of the Invention

The present invention relates to gardening without chemicals, and more particularly to a long or short handled weed extraction home garden implement having combined features that facilitate easy and efficient planting, weeding, loosening and leveling of the soil in a garden without requiring repetitive kneeling or stooping by the user.

2. Description of the Prior Art

Home gardening is a popular pastime, particularly among those individuals having sufficient time and patience. Because home gardening is generally done on a small scale such as a flowerbed, backyard or kitchen garden, it is generally neither economical nor practical to employ the large-scale machinery, sprays and practices used in the commercial agricultural industry. As a result, a home gardener is relegated to the use of numerous simple hand tools for planting, cultivating and maintaining the garden. Among the most distasteful of the tasks facing a home gardener is that of eradicating weeds from the garden.

Numerous hand tools have been developed over time for the purpose of facilitating weed removal. However, many of these tools suffer from drawbacks that affect their usefulness. Claw or jaw weeding devices have a pair of blades that are designed to be placed next to the main stem of the weed and dug in below to remove the weed and roots. However, such devices are tedious to use since they may be used on only one weed at a time, they require exact placement, and they call for the user to stoop or kneel very close to the weed to properly eradicate it. For those persons suffering from physical impairments or disabilities, bending or kneeling repetitively to remove weeds may be prohibitively difficult, painful, or exhausting. Moreover, if improperly used, such claws or other similar tools may merely cut off the weed at the surface, leaving the severed weed in the garden and leaving intact the root structure below. This poses a two-fold problem in that the severed weed may still spread seeds into the garden, and the weed is likely to grow back from the old root system requiring the process to be repeated.

In home gardening, it is also often necessary to utilize more than one tool to adequately perform the weeding function. First, a hoe or cultivator is used to loosen up the soil around the weeds. Then a claw or jaw is used to remove the weeds. Finally, a rake is used to remove the severed weeds. This increases the time and effort necessary for the task of weed removal, making it even less desirable to do.

It is therefore desirable to provide a weed eradication tool that is capable of efficiently removing both a weed and substantially all of its associated root system, and that does not require the user to kneel, stoop, bend over or grab hold of the weed when it is in the ground, making the tool more available for use by persons having physical limitations.

### SUMMARY OF THE INVENTION

The present invention provides a useful and conveniently combined home garden tool that may be used to easily and efficiently remove weeds, dig or level the soil, and plant seeds all without repetitive kneeling or stooping. The invention includes a long or short handle attached to a unique head having a combined weed remover (or weed chucker), pointed trenching tool and soil leveler. In an alternative embodiment, the trenching tool portion may be replaced by a flat-ended tool or hoe.

The weed removal section of the unique head is found at one end, and includes a plurality of generally parallel elongated fingers or tines, each tine having a pointed end. Each tine is round, as opposed to flat, having a generally cylindrical cross section. The tines are spaced apart from each other to form narrow openings between pairs of tines, each opening or slot having the form of an elongated V. The plurality of tines has a generally perpendicular orientation in relation to the handle of the tool (i.e., approximately 90°). A pointed or flat trenching tool is located at the opposite end of the head, and is oriented in the same plane as the tines, generally perpendicular to the handle. In one embodiment, the tines are oriented at less than 90° (e.g., approximately 80°) such that the trenching tool is oriented at greater than 90° (e.g., approximately 110°) in relation to the handle. An elongated flat member is provided between the tines and the trenching tool to provide a flat edge along the side of the tool head.

In use, the pointed ends of the tines of the weed chucker are placed near the base of a weed, preferably on the far side of the weed, and then pulled against the weed using the tool handle. With an elongated handle, this action may be accomplished by the user from a standing or sitting position. The angle of incidence of the tines should be such that they break the surface of the earth around the base of weed and penetrate into the soil below. However, this angle need not be very severe, only about 10° to 20°. The weed stalk is then caught in the V-shaped slots between the tines, leaving the tines buried in the soil. When this point is reached, the user pulls on the handle, tilting it such that the ends of the tines break back through the surface of the soil. This action dislodges both the weed and substantially all of its root system that is caught in the slots between the tines of the tool. At this point the entire weed may then be removed by withdrawing the head of the tool which takes the weed with it, and then shaking the tool or otherwise dislodging the weed that has been brought up to hand level to be properly discarded. In situations where the weeds are in close proximity to each other, multiple weeds may be removed using the tool with a single sweep or chop.

The pointed trenching tool at the opposite end of the tool head may be used to dig holes or furrows for planting seeds or seedling plants, and the like. The flat embodiment of the trenching tool may be used as a hoe. The bar between the tines and the trenching tool is available for smoothing or leveling soil such as after planting seeds that have been dropped into the trench, or removing weeds.

When the tool head is attached to a long handle, all of the above-described activities may be accomplished from a distance, allowing the user to be standing or sitting (not repetitively kneeling or stooping). This embodiment is of particular benefit to those with physical limitations. Of course, when the tool head is attached to a shorter handle, the user will be required to kneel or stoop for proper use of the tool.

It is therefore a primary object of the present invention to provide a single tool that may be used in a home garden for the multiple functions of weeding, planting, leveling and loosening of the soil.

It is also a primary object of the present invention to provide a single tool for the multiple uses of weeding, planting, loosening and leveling the soil in a home garden for use by the physically impaired, the tool having operable utility without requiring the user to repetitively kneel or stoop during use.

It is also an important object of the present invention to provide an apparatus for easily and efficiently eradicating weeds by removing substantially all of each weed and its associated root system without the use of chemicals.

Additional objects of the invention will be apparent from the detailed descriptions and the claims herein.

### BRIEF DESCRIPTION OF THE DRAWINGS

FIG. 1 is a perspective view of a long handled embodiment of the present invention.

FIG. 2 is a close up perspective view of the embodiment of FIG. 1.

FIG. 3 is another perspective view of the embodiment of FIG. 1.

FIG. 4 is an environmental view of the invention in use digging a furrow.

FIG. 5 is an environmental view of the invention in use removing a weed.

FIG. 6 is an environmental view of the invention in use leveling the soil.

FIG. 7 is a perspective view of an alternative embodiment of the present invention.

FIG. 8 is a close up perspective view of a short handled embodiment of the present invention.

FIG. 9 is a close up perspective view of the embodiment of FIG. 7.

### DETAILED DESCRIPTION OF A PREFERRED EMBODIMENT

Turning to the drawings, where like reference characters refer to the same structure throughout the several views, and referring particularly to FIG. 1, it is seen that the garden tool of the present invention includes a head generally indicated by the numerals 10, attached to a handle 22 with or without a ferrule 21. An elongated handle 22 may be used as illustrated in FIG. 1, or a shorter handle may be used as illustrated in the embodiment of FIG. 8.

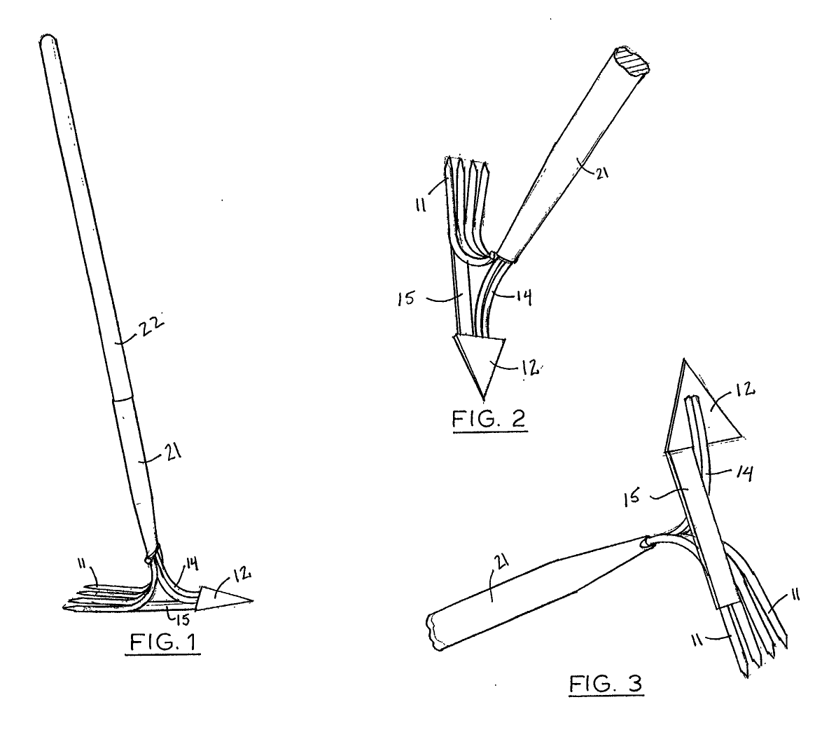

The head 10 includes a plurality of fingers or tines 11 at one end that are in spaced relation to each other so as to form elongated V-shaped openings or slots therebetween. It is to be noted that any suitable number of tines 11 may be employed, the embodiments of FIGS. 1-8 illustrating, for example, four tines, and the embodiment of FIG. 9 illustrating an alternative using five or six tines. The tines 11 are disposed in a single plane and are generally parallel to each other. Tines 11 are preferably pointed at their outer ends, each tine preferably having a round or circular cross section. However, in alternative embodiments the tines 11 may be flat having more of a rectangular cross section. The tines are attached directly to ferrule 21, or to handle 22 or 16 such that they have a generally perpendicular orientation with respect to the handle. In the preferred embodiment, the upper portions of the elongated tines are bent at an angle for attachment to the handle or ferrule. This angle should generally be about 90 degrees, but is preferably about 80 degrees to facilitate easier use for weed eradication as described herein.

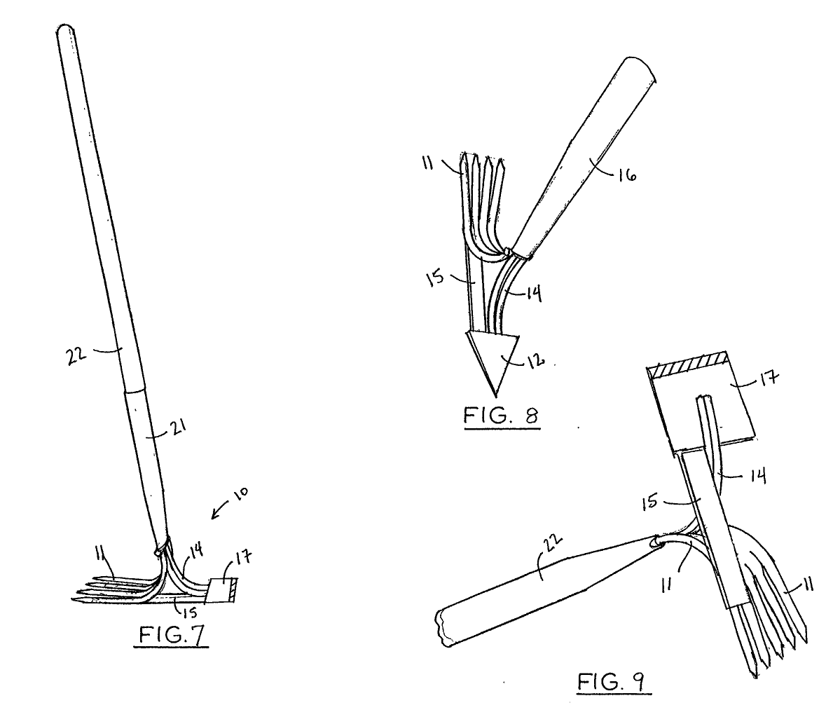

At the opposite end of head 10, a trenching tool 12 is provided. It is preferred that the trenching tool 12 include a pointed or spaded end for digging holes, furrows or for moving decorative rock, gravel or small river rock where weeds have grown. However, in an alternative embodiment, the trenching tool may be in the form of a flat piece 17 having the function of a hoe, as shown in FIGS. 7 and 9.

In another embodiment, between the tines 11 at one end of head 10 and the trenching tool 12 at the opposite end, a lateral bar member 15 may be provided. Bar 15 is attached at one end to tines 11 and attached at its opposite end to trenching tool 12, adding both stability and a straight edge to head 10.

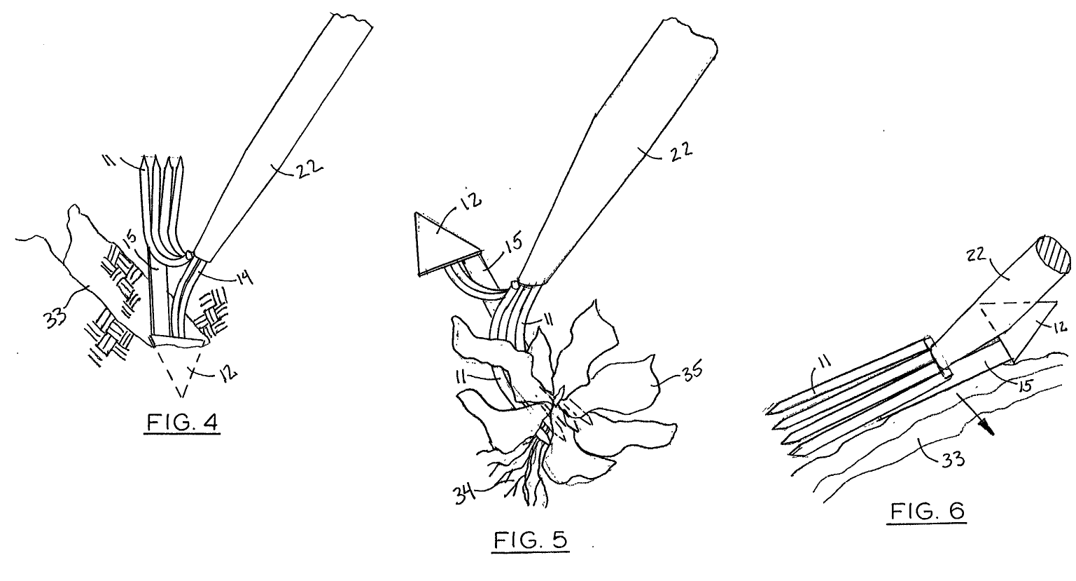

In use, the tines 11 of the present invention may be used to dig into or loosen the soil of a garden. For weed removal, tines 11 are dug into the soil 33 around a weed or weeds 35 until the stalk or shaft of the weed(s) is caught in the V-shaped slots between the tines. Then the tool handle 22 is pulled or moved in an arcuate direction forcing the tines 11 upward thereby uprooting the weed(s) as illustrated in FIG. 5. The uprooted weed(s) is then dislodged from the tines by the user (using fingers or by shaking) and discarded away from the garden. The pointed trenching tool 12 may be used to dig holes or furrows as illustrated in FIG. 4 into which plants may be inserted or seeds dropped. Such furrows may then be covered and leveled using the straight edge of bar 15, if provided, as shown in FIG. 6. In the alternative embodiment of FIGS. 7 and 9, trenching tool 17 may be used as a hoe. Accordingly, the single tool of the present invention allows a user to remove weeds, loosen soil, dig holes, plant seeds and cover them with soil, all without having to retrieve another tool, and all without the user having to repetitively kneel, stoop or bend.

Without limiting the scope of the present invention and by way of illustrative example only, in one embodiment of the invention the tines 11 may be in the form of pointed metal rods of approximately one-fourth inch (¼″) diameter, the distance between the tines at the tips or points being approximately three-eighths inch (⅜″) to approximately one half inch (½″), the length of each V-shaped slot being approximately three inches (3″), with each slot tapering to a width of approximately one-eighth inch (⅛″) where the tines join together at the base. The lower portion of the tines 11 in this example may be separated from the rod by an angle of approximately 80 degrees, said lower portion extending out approximately four inches (4″). The trenching tool 12 has triangular pointed sides that are approximately three inches (3″) in length, and bar 15 is approximately one-half inch (½″) wide by approximately four inches (4″) long, the distance between the lower portion of the tines 11 and the back edge of the trenching tool 12. The long handle 22 is approximately four and one-half feet (4½′) in length and approximately one and one-fourth inch (1¼″) in diameter. Of course, numerous other dimensions and combinations of dimensions may be used for the present invention depending upon the conditions in which it is to be used and the preferences of the user.

Thus, the gardening implement of the present invention includes a head 10 that is perpendicularly oriented with respect to either a long or short handle, one end of the head including a plurality of tines 11 useful for loosening of the soil or weed removal, the opposite end including a trenching tool that may have a pointed 12 (e.g., a spade) or flat 17 (e.g., a hoe) configuration. Between the opposite ends of head 10 a lateral bar 15 is provided for pushing, covering or leveling soil. Either embodiment of the head 10 may be provided with a long or short handle, the preferred long-handled versions allowing use of the tool to take place without stooping or kneeling.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A garden implement for the removal of weeds comprising a handle attached to a head, said head including a plurality of substantially parallel elongated tines, the proximal ends of said tines being attached to each other and to said handle, the distal ends of each tine being pointed, the tines being spaced apart from each other to form narrow gaps between pairs of tines, each such gap having the form of an elongated V.

2. The garden implement of claim 1 wherein each tine is generally cylindrical having a round cross section.

3. The garden implement of claim 2 wherein said plurality of tines has a generally perpendicular orientation in relation to said handle.

4. The garden implement of claim 2 wherein said plurality of tines are oriented at an acute angle in relation to said handle.

5. The garden implement of claim 4 wherein the distal ends of said tines define one end of said head, and a trenching tool is provided at the opposite end of said head, said trenching tool being oriented in the same plane as said tines.

6. The garden implement of claim 5 wherein a cross member is provided on said head between said tines and said trenching tool.

7. The garden implement of claim 5 wherein said trenching tool has a flat end.

8. The garden implement of claim 5 wherein said trenching tool has a pointed end.

9. The garden implement of claim 8 wherein the gaps between the tines at their distal ends are between about ½ inch and about ⅜ inch wide, the lengths of said gaps between the tines are about 3 inches, and the gaps at the proximal ends of the tines are about ⅛ inch wide.

10. The garden implement of claim 9 wherein said handle has a length of approximately 4½ feet.

11. A method for the removal of weeds and substantially all of their associated roots without requiring repetitive kneeling or stooping comprising the steps of:
a. penetrating the soil in the near vicinity of at least one weed with the pointed tines of a garden implement, said implement having a plurality of substantially parallel elongated tines, the proximal ends of said tines being attached to each other and attached at an acute angle to a handle, the distal ends of each tine being pointed, the tines being spaced apart from each other to form narrow gaps between pairs of tines, each such gap having the form of an elongated V;
b. pulling said implement such that said at least one weed is trapped in the gaps between said tines;
c. tilting said implement to dislodge the root system associated with said at least one weed; and
d. removing the trapped at least one weed and associated root system.
